(19) United States
(12) Patent Application Publication
(10) Pub. No.: US 2010/0071501 A1
(43) Pub. Date: Mar. 25, 2010

(54) REVOLVING BICYCLE HANDLE

(76) Inventor: John Michael LANE, New York, NY (US)

Correspondence Address: MICHAEL RIES, 318 PARKER PLACE, OSWEGO, IL, 60543, US

(21) Appl. No.: 12/562,124

(22) Filed: Sep. 17, 2009

Related U.S. Application Data
(60) Provisional application No. 61/098,729, filed on Sep. 19, 2008.

(51) Int. Cl. B62K 21/16; B62K 21/26

(52) U.S. Cl. 74/551.4; 74/551.9; 74/523

(57) ABSTRACT

First and second handle bar segments located on respectively opposite sides of a horizontal connector is attached to a revolving bicycle handle. Each bicycle revolving handle has a control member rotatably coupled to a core member that is rigidly attached to the handle bar segment. A pin that is coupled to the control member and operated by a finger operated lever selectively disengages the control member from the core member to allow the control member, and a hand grip attached to the control member, to revolve 360 degrees about the handle bar segment.

### REFERENCE TO RELATED APPLICATIONS

This patent application claims the benefit of U.S. Provisional Application No. 61/098,729 filed on Sep. 19, 2008, the disclosure of which is incorporated herein in its entirety by reference.

### BACKGROUND OF THE INVENTION

1. Field of the Invention

The present invention relates generally to a bicycle handle and more particularly to an auxiliary handle that is attached to the end of a conventional handle bar of a bicycle that allows the rider to adjust the position of the handle 360 degrees around the handle bar while riding to provide additional riding positions for a user

2. Description of Related Art

Bicycles are being used more frequently in the city and suburbs as a means of recreation, for transportation, and for racing. Regardless of how a bicycle is being used, various components on the bicycle are continuously being redesigned and improved by bicycle manufacturers. One part of the bicycle that has undergone considerable modification in the past few years is the design of the handle bar. As a result there are various types and configurations of handle bars that are available for a person to use. A standard type of handle bar that is currently available consists of a horizontal bar that has a generous bend at each end to form a handle for each hand. The center of the horizontal bar is connected to a stem member that is coupled to the front fork of the bicycle. The horizontal member is normally a tube which supports brake calipers and a derailleur device. The handles on the standard bicycle handle bar are fixed and, therefore, can be uncomfortable to hold.

### SUMMARY OF THE INVENTION

An object of the present invention is to provide a new improved bicycle handle bar end that has improved ergonomics.

Another object of the invention is to provide a bicycle handle bar end that provides multiple holding positions.

Another object of the present invention is to provide a bicycle hand bar end which is relatively simple in design and inexpensive to manufacture.

In an exemplary embodiment of the present invention, the foregoing objects are attained by providing a bicycle handle bar comprising:

a horizontal connection piece;

first and second handle bar segments located on respectively opposite sides of said horizontal connection piece,

first and second control members coupled to a core member which is coupled to said first and second handle bar segments; and

first and second hand grips coupled to said first and second control members.

In another exemplary embodiment of the present invention, the foregoing objects are attained by providing a revolving handle for attachment to a handle bar segment located on an end of a horizontal bar of a bicycle handle bar comprising:

a control member;

a hand grip coupled to said control member; and

a core member rotatably coupled to said control member;

wherein said core member is adapted to be coupled to said handle bar segment.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of a bicycle with a standard handle bar;

FIG. 2 is a top view of a standard bicycle handle bar;

FIG. 3 is a partial bottom sectional view of the revolving bicycle hand grip attached to a standard bicycle handle bar in accordance with the principles of the invention; and

FIG. 4 is a side sectional view of the left revolving bicycle hand grip attached to a standard bicycle handle bar in accordance with the principles of the invention.

### DESCRIPTION OF THE PREFERRED EMBODIMENT

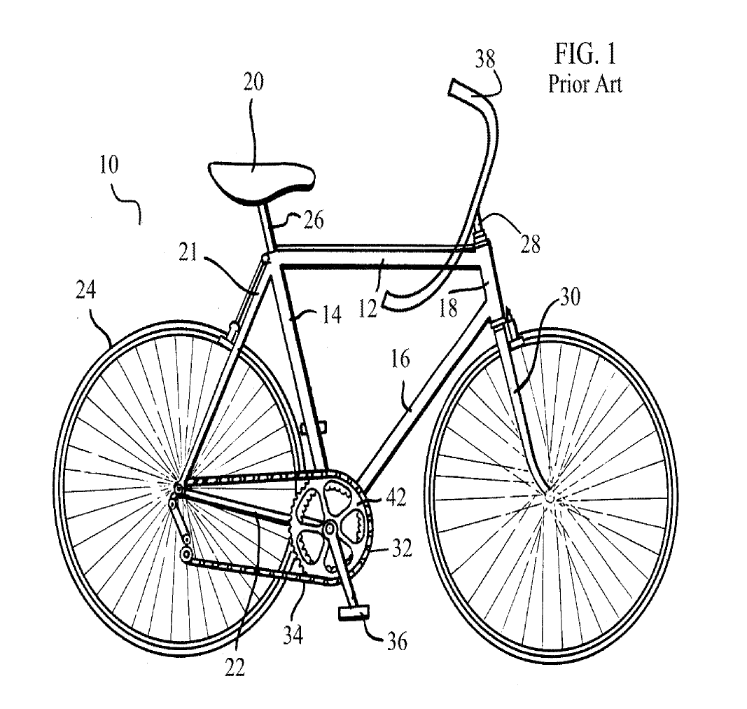

Referring to FIG. 1, there is shown a side view of a bicycle with a standard handle bar. The bicycle 10 has a top tubular member 12, a substantially vertical tube 14, a diagonally positioned tube 16, and a fork tube 18 connected together to form a substantially triangular frame. A seat 20 is connected to a support tube 26 which can be moved up and down and locked in position to the tube 14. Back tubes 21 and chain tubes 22 are connected together and are connected to the axel of a rear wheel 24. Located within the fork tube 18 is a stem 28 which is connected at one end to the fork 30. The rear wheel 24 is driven by pedals 36 connected to a sprocket wheel 32 and chain 34. Located at the top of the stem 28 is a handle bar such as a standard handle bar 38.

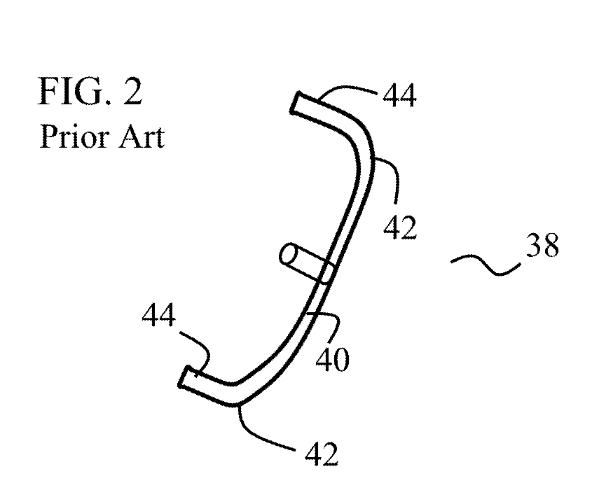

Referring to FIG. 2 there is shown a standard prior art handle bar 38 for a bicycle. The standard handle bar normally consists of a horizontal connection piece or bar 40 that may have a generous bend 42 or may be straight to form segments at each end to form a handle 44 for each hand. The center of the horizontal bar is connected to the stem member with a clamping member. The horizontal member is normally a tube which is attached to a clamp on the stem. The horizontal bar can be rotated about the stem and the stem can be raised or lowered relative to the frame. The ends of the horizontal bar may be bent or may be straight bar to form segments or handles 44 that are adapted to be grasped by a rider.

The revolving bicycle handle here disclosed solves the problem of a limited riding position for a bicycle rider. The revolving bicycle handle is attached to a bicycle handle bar and allows a rider to adjust his/her hand position as he/she rides to provide additional riding positions. The revolving bicycle handle differs from existing bicycle handles in that the handles are not fixed to a single position while a person is moving. The revolving bicycle handles allow a rider to adjust the position of the handle 360 degrees around the end of the standard bicycle handle while the bicycle is moving.

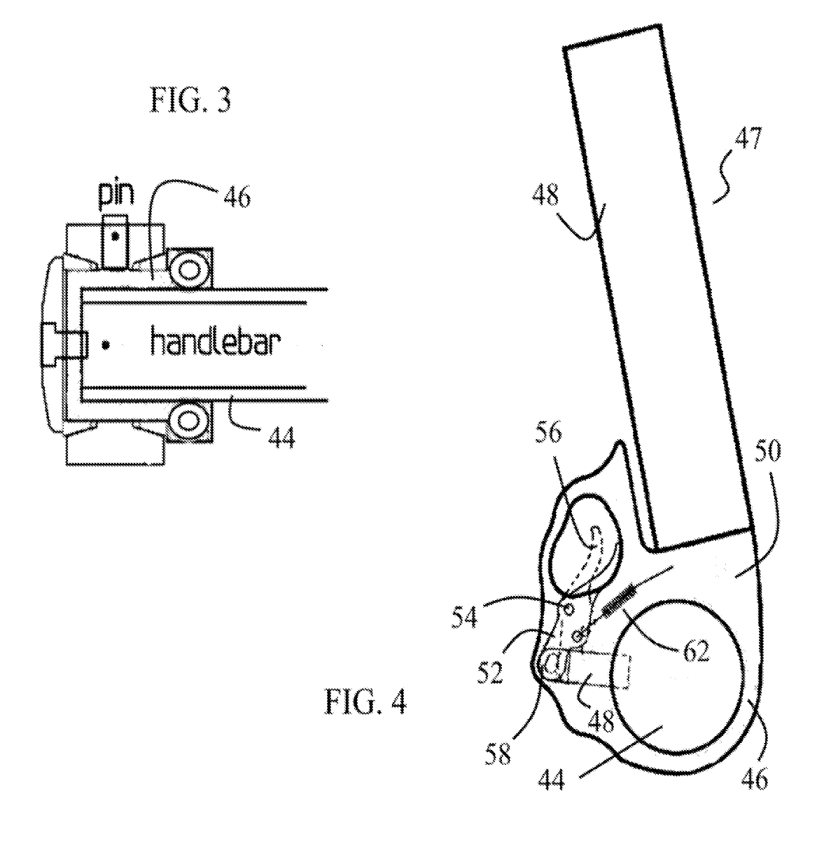

Referring to FIG. 3, there is shown a partial bottom sectional view of the revolving bicycle handle attached to a standard bicycle handle in accordance with the principles of the invention. The revolving handle includes a core member 46 that is securely attached to the handle 44 of a standard bicycle handle. The revolving handle member rotates around a core member that is attached to the standard bicycle handle.

Referring to FIG. 4, there is shown a side sectional view of the left revolving bicycle handle attached to a standard bicycle handle in accordance with the principles of the invention. The right revolving bicycle handle, not shown, is a mirror image of the left revolving bicycle handle. The revolving handle member includes a hand grip 48 attached to a control member 50. Located within control member is a finger operated lever 52 which rotates about pin 54. One end 56 of lever 52 is positioned to be rotatably operated by the bicycle rider's finger. The other end 58 of the lever is pivotably coupled to an engagement pin 60. A spring 62 that is coupled to lever 52 urges pin 60 to frictionally engage and lock the control member and the handle 48 to the core member 46. Pressing on the end 56 of the lever 52 releases pin 60 from the core member and the revolving handle member 47 is free to rotate 360 degrees about the standard bicycle handle. The various parts of the revolving handle member 47 can be made of a plastic or any appropriate material and the hand grip 48 can have a soft rubber sleeve.

In use, a bicycle rider activates the movement of the revolving handle member 47 via the finger operated lever 52 which disengages the control member and the hand grip from the core member 46. Once a desired position of the revolving handle member 47 is achieved, the core member and the control member are locked together via the pin engaging the core member 46. The pin and core member may have fictional engagement between them.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A bicycle handle comprising:
a horizontal connection piece;
first and second handle bar segments located on respectively opposite sides of said horizontal connection piece,
first and second control members coupled to a core member, the core member is coupled to said first and second handle bar segments; and
first and second hand grips coupled to said first and second control members.

2. The bicycle handle of claim 1 wherein said first and second control members revolve about a longitudinal axis of said handle bar segments.

3. The bicycle handle of claim 2 wherein said first and second hand grips are perpendicular to the longitudinal axis of said handle bar segments.

4. The bicycle handle of claim 3 wherein said control members can rotate 360 degrees about the longitudinal axis of said handle bar segments.

5. The bicycle handle of claim 4 wherein said first and second control members each include a core member coupled to said handle bar segments.

6. The bicycle handle of claim 5 wherein said first and second core members are fixedly coupled to the handle bar segments.

7. The bicycle handle of claim 6 wherein each of said first and second control members includes a pin that removably engages said core members.

8. The bicycle handle of claim 7 wherein said control member are locked to said core members when said pin engages said core members.

9. The bicycle handle of claim 8 wherein a finger operated lever coupled to said control member is coupled to controllably release said pin from said core member.

10. The bicycle handle of claim 9 wherein said finger operated lever is coupled to a spring that urges said pin to engage said core member.

11. A revolving handle for attachment to a handle bar segment located on an end of a horizontal bar of a bicycle handle bar comprising:
a control member;
a hand grip coupled to said control member; and
a core member rotatably coupled to said control member;
wherein said core member is adapted to be coupled to said handle bar segment.

12. The revolving handle of claim 11 wherein said control member is rotatably coupled to said core member.

13. The revolving handle of claim 12 wherein said control member includes a pin that removably engages said core member to lock said control member to said core member.

14. The revolving handle of claim 13 wherein said control member can rotate 360 degrees about said core member when said core member is not engaged by said pin.

15. The revolving handle of claim 14 wherein said pin engages said core member.

16. The revolving handle of claim 15 wherein a finger operated lever located in said control member is coupled to selectively disengage said pin from said core member.

17. The revolving handle of claim 16 wherein a spring is coupled to said finger operated lever to urge said pin to engage said core member.

18. The revolving handle of claim 17 wherein said hand grip, when located on a handle bar segment on an end of a horizontal bar of a bicycle handle bar, can revolve 360 degrees about a longitudinal axis of said segment.

19. The revolving handle of claim 17 wherein said hand grip, when located on a handle bar segment on an end of a horizontal bar of a bicycle handle bar, is positioned perpendicular to a longitudinal axis of said segment.
